(19) United States
(12) Patent Application Publication
(10) Pub. No.: US 2013/0186764 A1
(43) Pub. Date: Jul. 25, 2013

(54) Low Etch Process for Direct Metallization

(71) Applicants: Kesheng Feng, Cheshire, CT (US); Jun Nable, Hamden, CT (US); Adam McCaherty, West Haven, CT (US)

(72) Inventors: Kesheng Feng, Cheshire, CT (US); Jun Nable, Hamden, CT (US); Adam McCaherty, West Haven, CT (US)

(21) Appl. No.: 13/353,428

(22) Filed: Jan. 19, 2012

(51) Int. Cl. C25D 5/34; C11D 7/60

(52) U.S. Cl. 205/210; 510/175

(57) ABSTRACT

An aqueous treatment solution for increasing the cleaning capability of a treated copper surface comprising: a) an organic compound selected from the group consisting of organic acids, alcohols, ketone, nitriles and combinations of one or more of the foregoing; and b) an oxidizing agent. The aqueous treatment solution is usable in a process for metallizing the walls of holes within a printed wiring board substrate having metallic and non-metallic regions, wherein the printed wiring board is treated with a reducing agent and then contacted with an aqueous dispersion of carbonaceous particles to term a coating of the dispersion over the substrate. The process comprises the step of contacting the metallic regions of the printed wiring board substrate with the aqueous treatment solution to remove deposited carbonaceous particles therefrom. The aqueous treatment solution provides a clean copper surface while providing a low microetch rate.

### FIELD OF THE INVENTION

The present invention relates generally to a process for enhancing the electroplating of non-conductive surfaces, such as through holes of printed wiring boards and aqueous treatment solutions for use therein.

### BACKGROUND OF THE INVENTION

Printed wiring boards (also known as printed circuit boards or PWB's) are generally laminated materials comprised of two or more plates of foils of copper, which are separated from each other by a layer of non-conducting material. Although copper is generally used as the electroplating metal in printed wiring boards, those skilled in the art will recognize that other metals such as nickel, gold, palladium, silver and the like can also be electroplated. The non-conducting layer(s) preferably comprise an organic material such as an epoxy resin impregnated with glass fibers, but may also comprise thermosetting resins, thermoplastic resin, and mixtures thereof, alone or in combination with reinforcing materials such as fiberglass and fillers.

In many printed wiring board designs, the electrical pathway or pattern requires a connection between the separated copper plates at certain points in the pattern. This is usually accomplished by drilling holes at the desired locations through the laminate of copper plates and the non-conducting layer(s) and then connecting the separate metal plates. Subsequently, these through hole walls of the printed wiring board are prepared for electroplating. These plated through hole walls are necessary to achieve connections between two metal circuit patterns on each side of a printed wiring board, or in addition to this, between the inner layer circuit patterns of a multilayer board.

One advantageous way of preparing the through hole walls for electroplating utilizes an aqueous dispersion of carbonaceous particles such as carbon black or graphite particles to produce through holes that are made relatively smooth for plating.

In this process, the printed wiring board is preferably subjected to a precleaning process in order to place the printed wiring board in condition for receiving a liquid carbon black or graphite dispersion. After application of the cleaner, the PWB is rinsed in water to remove excess cleaner from the board and then contacted with a conditioner solution. The conditioner solution is used to ensure that substantially all of the through hole wall glass/epoxy surfaces are properly prepared to accept a continuous layer of the subsequently applied carbon black or graphite particles. See, for example, U.S. Pat. No. 4,634,691 to Lindsey, the subject matter of which is herein incorporated by reference in its entirety, which describes a suitable conditioner solution.

The liquid carbon black or graphite dispersion is then applied to or contacted with the conditioned PWB. This dispersion contains three critical ingredients, namely, carbon black or graphite, one or more surfactants capable of dispersing the carbon black or graphite and a liquid dispersing medium such as water. The carbon black or graphite covered board is next subjected to a step where substantially all (i.e., more than about 95% by weight) of the water in the applied dispersion is removed and a dried deposit containing carbon black or graphite is left in the through holes and on other exposed surfaces of the non-conducting layer. To insure complete coverage of the through hole walls, the procedure of immersing the board in the liquid carbon black or graphite dispersion and then drying may be repeated.

The carbon black or graphite dispersions on the PWB not only coat the drilled through hole surfaces, which is desirable, but also entirely coats the metal (i.e., copper) plate or foil surfaces, which is undesirable. Therefore, prior to many subsequent operations, all of the carbon black or graphite must be removed from the copper plate and/or foil surfaces.

The removal of the carbon black or graphite, specifically from the copper surfaces including, especially, the rims of the drilled holes while leaving the coating intact on the glass fibers and epoxy surfaces of the hole walls, has typically been accomplished by the employment of a mechanical scrubbing operation.

After removal of the extraneous carbon, the PWB may either proceed to a photo imaging process and later be electroplated, or be directly panel electroplated. The thus treated printed wiring board is then ready for the electroplating operation which includes immersing the PWB in a suitable electroplating bath to apply a copper coating on the through hole walls of the non-conducting layer.

These microetch processes have been widely used, and the microetch is typically controlled at about 40 to 60 microinches. However, the microetch frequently causes problems, particularly in plating in the area of the copper dielectric interface. In particular, etching the copper changes the resistance of the areas etched.

Traditionally, the microetch of the copper surface is lowered by employing one or more of the following methods: (1) less oxidant; (2) lowering the temperature of the microetching solution; and/or (3) shorter contact time. The drawback to the use of these methods is that they have all been shown to contribute to a less clean copper surface, thereby increasing the number of defects.

### SUMMARY OF THE INVENTION

It is an object of the present invention to produce a clean metal surface with a low microetch of the metal.

It is another object of the present invention to provide an aqueous treatment solution that is capable of producing a clean copper surface.

It is another object of the present invention to provide an aqueous treatment solution that is capable of producing a low microetch of copper.

It is still another object of the present invention to provide an improved process for metallizing the walls of holes in a printed wiring board substrate.

To that end, in one preferred embodiment, the present invention relates generally to an aqueous treatment solution for increasing the cleaning capability of a treated copper surface comprising:

a) an organic compound selected from the group consisting of organic acids, alcohols, ketones, nitriles and combinations of one or more of the foregoing;

b) an oxidizing agent; and

c) optionally, acid.

In another preferred embodiment, the present invention relates generally to a process of plating a non-conductor comprising:

contacting the non-conductor with a carbon dispersion;

b) contacting the non-conductor with an aqueous treatment solution comprising:
i) an organic compound selected from the group consisting of organic acids, alcohols, ketones, nitriles and combinations of one or more of the foregoing; and
ii) an oxidizing agent; and
iii) optionally, acid; and

c) thereafter electroplating the non-conductor.

### DETAILED DESCRIPTION OF THE PREFERRED EMBODIMENTS

The inventors of the present invention have found that an aqueous treatment solution which contains:
(1) an organic compound selected from the group consisting of organic acids, alcohols, ketones, nitriles and combinations of one or more of the foregoing;
(2) an oxidizing agent; and
(3) optionally, acid;
   has the capability of increasing the cleaning of a treated metal (i.e., copper) surface while dramatically reducing the microetch of the copper surface to about 1-20 μin. The organic compound provides a low microetch (i.e., 1-20 μin) while providing a clean copper surface.

The aqueous treatment solution may also contain a small amount of acid, especially sulfuric acid. If used, the sulfuric acid is typically present in the aqueous treatment solution at a concentration of between about 0.5 to 3%, more preferably about 1%.

Suitable organic acids include citric acid, succinic acid, glycolic acid, malic acid, tartaric acid, and combinations of one or more of the foregoing. In a preferred embodiment, the organic acid is citric acid. Other organic acids would also be usable in the aqueous treatment solution of the present invention.

Suitable operating conditions for a citric acid-persulfate system include a citric acid concentration of between about 20-100 g/L and a sodium persulfate concentration of between about 80-150 g/L, with an etch rate at 8-10 μin/min, a bath temperature of 45-50° C. and a dwell time in the aqueous treatment solution of about 60 seconds. Suitable operating conditions for other organic acids in combination with sodium persulfate or another oxidizing agent, such as hydrogen peroxide, would be similar.

Suitable alcohols include sec-butanol, 2-propanol, 1,2-dipropanol, 1-propanol, furfuryl alcohol, polyethylene glycol, 1-methoxy-2-propanol, 2-ethoxyethanol, 2-butoxyethanol, 2-butoxyethyl acetate, diethylene glycol monoethyl ether, dipropylene glycol monoethyl ether, 1,2-propanediol and combinations of one or more of the foregoing. Other secondary alcohols or solutions containing an alcohol functional group would also be usable in the composition of the present invention.

Suitable ketones and nitriles include acetone, 4-hydroxy-4-methyl-2-pentanone, adiponitrile and combinations of one or more of the foregoing. Acetone and adiponitrile are especially preferred. In addition, other ketones and nitriles would also be usable in the composition of the present invention.

The oxidizing agent may typically be selected from the group consisting of a persulfate, hydrogen peroxide, potassium hydrogen peroxymonosulfate and combinations of one or more of the foregoing. In a preferred embodiment, the oxidizing agent comprises sodium persulfate.

The present invention also provides a method of treating the metallic regions of a printed wiring board substrate to remove deposited carbonaceous particles therefrom by contacting the substrate with the aqueous treatment solution described herein.

In another preferred embodiment, the present invention relates generally to a process of plating a non-conductor comprising:

a) contacting the non-conductor with a carbon dispersion;

b) contacting the non-conductor with an aqueous treatment solution comprising:
i) an organic compound selected from the group consisting of organic acids, alcohols, ketones, nitriles and combinations of one or more of the foregoing; and
ii) an oxidizing agent; and
iii) optionally, acid; and

c) thereafter electroplating the non-conductor.

In one embodiment, the non-conductor comprises a printed wiring board substrate comprising metallic and non-metallic regions.

As described herein, it is desirable that the microetch rate of at least a portion of the metallic region of the non-conductor be controlled to less than 20 μin/min, more preferably less than 10 μin/min.

In a preferred embodiment, the step of contacting the non-conductor with the aqueous treatment solution comprises immersing the non-conductor in the aqueous treatment solution for a period of time. For example, a printed wiring board substrate may be immersed in the aqueous treatment solution for 1 to 3 minutes, more preferably for about 1 minute. The aqueous treatment solution is preferably maintained at a temperature of between about 30 and about 50° C. during the immersion step, and more preferably, the aqueous treatment solution is maintained at a temperature of between about 45 and 50° C.

One example of a typical direct metallization process is known as the “Blackhole® SP Process Cycle,” (available from MacDermid., Inc., Waterbury, Conn.) and typically comprises the steps outlined below:
(1) Conditioner (Blackhole® SP Conditioner, available from MacDermid, Inc., Waterbury, Conn.)
(2) Water rinse
(3) Blackhole® carbon black dispersion (Blackhole® carbon black dispersion, available from MacDermid, Inc., Waterbury, Conn.)
(4) Heated dry
(5) Microclean (Blackhole® Microclean, available from MacDermid, Inc., Waterbury, Conn.)
(6) Rinse
(7) Anti-tarnish (Blackhole® Antitarnish, available from MacDermid, Inc., Waterbury, Conn.)
(8) Rinse
(9) Dry

In this process, Blackhole® Microclean (Step 5) is used to microetch and clean the metallic regions of the printed wiring board to remove carbonaceous particles therefrom. As discussed above, this microetch composition typically comprises sulfuric acid and an oxidizing agent such as sodium persulfate. However, in this process, it is necessary to have an etch rate of 40-60 μin/min in order to get a clean copper surface. Carbon black or graphite residue has historically been observed when the etch rate is below 40 μin/min.

Therefore, it was desirable to evaluate aqueous treatment solutions as described herein to determine if such aqueous treatment solutions would be capable of producing a low etch rate while still achieving a clean copper surface. Thus, it was found that various organic compounds were shown to provide beneficial results with respect to both the microetch rate and the cleaning of the metallic regions of the printed wiring board.

The following non-limiting examples illustrate suitable aqueous treatment solutions and associated process conditions in accordance with the present invention.

### Example 1

An aqueous treatment solution was prepared comprising:

50 g/L of citric acid

20 g/L of sodium persulfate.

The etch rate was at 3 pin/min. The solution was optimized, and the aqueous treatment solution was tested in accordance with the process cycle described above. The chemistry of citric acid and sodium persulfate was directly compared to the Microclean® (available from MacDermid Inc.) chemistry (i.e., sulfuric acid with sodium persulfate).

10-layer boards were used to check carbon residue in the through holes as well as on the copper surface.

The through holes and copper surfaces were cleaned by the citric acid/persulfate solution described herein under an etch rate of 3.0 μin/min and achieved a good result and it was found that a solution of citric acid and sodium persulfate was particularly effective at removing carbonaceous particles from copper surfaces.

Using a microetch solution comprising 1.5% sulfuric acid and 25 g/L of a persulfate solution, the etch rate was at 14 μin/min, using a bath temperature of 30° C. and a line speed of 1.0 m/min, it was observed that the holes were cleaned but that the surface was not clean.

Even when the microetch rate was increased to 19 μin/min by adding extra sodium persulfate in the solution of sulfuric acid/sodium persulfate, the copper surface was still not clean.

### Example 2

An aqueous treatment solution of 20 of glycolic acid and 80 g/L of sodium persulfate was mixed together in a beaker. The bath temperature was at 45° C., the microetch rate was 2.6 μin/min, and carbon coating on the copper surface was removed, completely within 1 minute.

### Example 3

An aqueous treatment solution of 125 g/L of citric acid and 3% hydrogen peroxide was mixed together in a beaker. The bath temperature was at 38° C., the microetch rate was 18.2 μin/min and the carbon coating on the copper surface was removed completely within 1 minute.

The citric acid-sodium persulfate aqueous treatment solution showed efficiency in removing carbon on copper both in inner-layer holes and on copper surfaces with an etch rate of 3-10 μin/min in Blackhole® SP direct metallization processes (available from MacDermid, Inc.). The surface cleaned by the citric acid-sodium persulfate aqueous treatment solution was much cleaner than that cleaned by a sulfuric acid-sodium persulfate micro-etch solution during the test performed.

It was also found that a solution of an organic acid and hydrogen peroxide also has the efficiency to remove carbon black coating on copper surfaces.

Citric acid-persulfate aqueous treatment solutions showed efficiency to remove carbon on copper both in inner layer holes and copper surfaces with an etch rate of 5 to 10 μin. The surface cleaned by this citric acid-persulfate aqueous treatment solution was much cleaner than that cleaned by a Microclean® solution during the tests performed.

### Example 4

Additional organic acids as well as various alcohols, ketones and nitriles were selected to evaluate their activity on carbon removal in a direct metallization process.

Alcohols that were tested included sec-butanol, 2-propanol, 1,2-dipropanol, 1-propanol, furfuryl alcohol, polyethylene glycol, 1-methoxy-2-propanol, 2-ethoxyethanol, 2-butoxyethanol, 2-butoxyethyl acetate, diethylene glycol monoethyl ether and dipropylene glycol monoethyl ether.

Solutions containing an acid functional group that were tested included succinic acid, malic acid, tartaric acid, oxalic acid and glycolic acid.

Solutions containing a ketone or nitrile functional group that were tested included acetone, 4-hydroxy-4-methyl-2-pentanone and adiponitrile.

Laminate panels were coated using the Eclipse® direct metallization process (available from MacDermid, Inc., Waterbury, Conn.). All of the carbon removal tests were conducted in one liter beakers. The amount of sodium persulfate remained constant throughout the experiments at 80 g/L. The solutions were all heated to 45° C. and the laminate panel coupons were put into each treatment solution for one minute and then rinsed for one minute using deionized water or tap water.

The following solutions were used as described in Table 1 to compare the efficiency of the various solutions on carbon removal.

TABLE 1
Solutions for evaluating efficiency of solutions on carbon removal

| | Temperature | Etch Rate | Carbon |
|---|---|---|---|
| Solution | (° C.) | (μin/min) | Removed (%) |
| 1-methoxy-2-propanol (5 g/L) + persulfate (80 g/L) + 1% H₂SO₄ | 45 | 10.5564 | 99 |
| 2-butoxyethanol (5 g/L) + persulfate (80 g/L) + 1% H₂SO₄ | 45 | 6.6402 | 99 |
| 2-ethoxyethoxynol (5 g/L) + persulfate (90 g/L) + 1% H₂SO₄ | 45 | 4.7674 | 97 |
| 1,2-propanediol (10 g/L) + persulfate (80 g/L) + 1% H₂SO₄ | 30 | 4.9376 | 94 |
| 2-butoxyethyl acetate (5 g/L) + persulfate (80 g/L) + 1% H₂SO₄ | 45 | 4.5119 | 98 |
| Succinic acid (20 g/L) + persulfate (80 g/L) | 45 | 2.3837 | 85 |
| Glycolic acid (20 g/L) + persulfate (80 g/L) | 45 | 2.6390 | 95 |
| Acetone (0.5 g/L) + persulfate (80 g/L) | 45 | 10.301 | 90 |
| Adipontrile (20 g/L) + persulfate (80 g/L) | 45 | 3.150 | 90 |
| 4-hydroxy-4-methyl-2-penatanone (40 g/L) + persulfate (80 g/L | 45 | 27.923 | 88 |
| 2-propanol (5 g/L) + persulfate (80 g/L) | 45 | 4.682 | 95 |
| 2-propanol (10 g/L) + persulfate (80 g/L) | 45 | 5.022 | 92 |
| 1-methoxy-2-propanol (5 g/L) + persulfate (80 g/L) | 45 | 1.1918 | 98 |
| 1-methoxy-2-propanol (20 g/L) + persulfate (80 g/L) | 45 | 4.2566 | 98 |
| 1-methoxy-2-propanol (40 g/L) + persulfate (80 g/L) | 45 | 2.2985 | 98 |
| 2-ethoxyethanol (5 g/L) + persulfate (80 g/L) | 45 | 4.3417 | 95 |
| 2-butoxyethanol (5 g/L) + persulfate (80 g/L) | 45 | 0.8513 | 99 |
| 1,2-propanediol (5 g/L) + persulfate (80 g/L) | 45 | 26.135 | 100 |
| 1,2-propanediol (10 g/L) + persulfate (80 g/L) | 30 | 4.5971 | 90 |
| 2 butoxyethyl acetate (5 g/L) + persulfate (80 g/L) | 45 | 0.5959 | 85 |
| Diethylene Glycol Monoethyl Ether (5 g/L) + persulfate (80 g/L) | 45 | 4.5119 | 97 |
| Dipropylene glycol monoethyl ether (5 g/L) + persulfate (80 g/L) | 45 | 1.7878 | 98 |
| 2-propanol (5 g/L) + persulfate (80 g/L) + 1% H₂SO₄ | 45 | 20.6870 | 99 |
| 2-propanol (5 g/L) + persulfate (80 g/L) + | 30 | 9.364 | 98 |

In addition, it was also observed that the performance of various secondary alcohols and solvents containing an alcohol functional group could be enhanced by the addition of 1% sulfuric acid to the solution and/or by adjusting the temperature of the aqueous treatment bath.

These additional tests demonstrate that the use of various organic acids, alcohols, ketones and nitriles in aqueous treatment solutions in accordance with the present invention also beneficially results in a low microetch with a clean copper surface. These aqueous treatment solutions produce clean metal (i.e., copper) surfaces that avoid the plating defects observed in surfaces of the prior art.

What is claimed is:

1. An aqueous treatment solution for increasing the cleaning capability of a treated metal surface comprising:
a) an organic compound selected from the group consisting of organic acids, alcohols, ketones, nitriles and combinations of one or more of the foregoing; and
b) an oxidizing agent.

2. The aqueous treatment solution according to claim 1, further comprising sulfuric acid.

3. The aqueous treatment solution according to claim 2, wherein the sulfuric acid is present in the aqueous treatment solution at a concentration of between about 0.5 to about 2%.

4. The aqueous treatment solution according to claim 3, wherein the sulfuric acid is present in the aqueous treatment solution a concentration of about 1%.

5. The aqueous treatment solution according to claim 1, wherein the organic compound is an organic acid selected from the group consisting of citric acid, succinic acid, glycolic acid and combinations of one or more of the foregoing.

6. The aqueous treatment solution according to claim 5, wherein the organic acid comprises citric acid.

7. The aqueous treatment solution according to claim 5, wherein the organic acid is present in the aqueous treatment solution at a concentration of 20 to 100 g/L.

8. The aqueous treatment solution according to claim 1, wherein the organic compound is an alcohol selected from the group consisting of sec-butanol, 2-propanol, 1,2-dipropanol, 1-propanol, furfuryl alcohol, polyethylene glycol, 1-methoxy-2-propanol, 2-ethoxyethanol, 2-butoxyethanol, 2-butoxyethyl acetate, 2-propanediol, diethylene glycol monoethyl ether, dipropylene glycol monoethyl ether and combinations of one or more of the foregoing.

9. The aqueous treatment solution according to claim 8, wherein the alcohol is present in the aqueous treatment solution at a concentration of 5 to 80 g/L.

10. The aqueous treatment solution according to claim 1, wherein the organic compound is a ketone or nitrile selected from the group consisting of acetone, 4-hydroxy-4-methyl-2-pentanone, adiponitrile and combinations of one or more of the foregoing.

11. The aqueous treatment solution according to claim 10, wherein the ketone or nitrile comprises acetone or adiponitrile.

12. A process of plating a non-conductor comprising:
a) contacting the non-conductor with a carbon dispersion;
b) contacting the non-conductor with an aqueous treatment solution comprising:
i) an organic compound selected from the group consisting of organic acids, alcohols, ketones, nitriles and combinations of one or more of the foregoing; and
ii) an oxidizing agent; and
iii) optionally, sulfuric acid; and
c) thereafter electroplating the non-conductor.

13. The process according to claim 12, wherein a microetch rate of at least a portion of the non-conductor is less than 20 μin/min.

14. The process according to claim 13, wherein the microetch rate of at least the portion of the non-conductor is less than 10 μin/min.

15. The process according to claim 12, wherein the non-conductor is a printed wiring board substrate comprising metallic and non-metallic regions.

16. The process according to claim 12, wherein the non-conductor is contacted with the aqueous treatment solution by immersion.

17. The process according to claim 16, wherein the aqueous treatment solution is maintained at a temperature of between about 30 and about 50° C. during the immersion step.

18. The process according to claim 17, wherein the aqueous treatment solution is maintained at a temperature of between about 45 and 50° C. during the immersion step.

19. The process according to claim 12, wherein the step of contacting the non-conductor with the aqueous treatment solution comprises immersing the non-conductor in the aqueous treatment solution for a period of time.

20. The process according to claim 12, wherein the organic compound is an organic acid selected from the group consisting of citric acid, succinic acid, glycolic acid and combinations of one or more of the foregoing.

21. The process according to claim 20, wherein the organic acid comprises citric acid.

22. The process according to claim 12, wherein the organic compound is an alcohol selected from the group consisting of sec-butanol, 2-propanol, 1,2-dipropanol, 1-propanol, furfuryl alcohol, polyethylene glycol, 1-methoxy-2-propanol, 2-ethoxyethanol, 2-butoxyethanol, 2-butoxyethyl acetate, diethylene glycol monoethyl ether, dipropylene glycol monoethyl ether, 1,2-propanediol and combinations of one or more of the foregoing.

23. The process composition according to claim 12, wherein the organic compound is a ketone or nitrile selected from the group consisting of acetone, 4-hydroxy-4-methyl-2-pentanone, adiponitrile and combinations of one or more of the foregoing.

24. The process composition according to claim 23, wherein the ketone or nitrile comprises acetone or adiponitrile.
